(19) United States
(12) Patent Application Publication
(10) Pub. No.: US 2006/0083174 A1
(43) Pub. Date: Apr. 20, 2006

(54) Collision avoidance manager, method of avoiding a memory collision and a turbo decoder employing the same

(75) Inventors: Byonghyo Shim, San Diego, CA (US); Yanni Chen, Dallas, TX (US); Manish Goel, Plano, TX (US); Tod D. Wolf, Richardson, TX (US); Sriram Sundararajan, Plano, TX (US); Alan Gatherer, Richardson, TX (US)

Correspondence Address: TEXAS INSTRUMENTS INCORPORATED, P O BOX 655474, M/S 3999, DALLAS, TX, 75265, US

(73) Assignee: Texas Instruments Inc., Dallas, TX (US)

(21) Appl. No.: 11/239,498

(22) Filed: Sep. 29, 2005

Related U.S. Application Data
(60) Provisional application No. 60/616,069, filed on Oct. 4, 2004.

(51) Int. Cl. H04L 12/26

(52) U.S. Cl. 370/245

(57) ABSTRACT

The present invention provides a collision avoidance manager for use with single-port memories. In one embodiment, the collision avoidance manager includes a memory structuring unit configured to provide a memory arrangement of the single-port memories having upper and lower memory banks arranged into half-memory portions. Additionally, the collision avoidance manager also includes a write memory alignment unit coupled to the memory structuring unit and configured to provide double-data writing to the memory arrangement based on memory collision avoidance. In a preferred embodiment, the collision avoidance manager also includes a read memory alignment unit coupled to the memory structuring unit and configured to provide double-data reading from the memory arrangement while maintaining the memory collision avoidance.

### CROSS-REFERENCE TO PROVISIONAL APPLICATION

This application claims the benefit of U.S. Provisional Application No. 60/616069 entitled “Memory Management Apparatus to Resolve Memory Collision of Turbo Decoder Using Single Port Extrinsic Memory” to Byonghyo Shim, et al., filed on Oct. 4, 2004, which is incorporated herein by reference in its entirety.

### TECHNICAL FIELD OF THE INVENTION

The present invention is directed, in general, to signal processing and, more specifically, to a collision avoidance manager, a method of avoiding a memory collision and a turbo decoder employing the manager or the method.

### BACKGROUND OF THE INVENTION

The basis of Turbo coding, which is an advanced error correction technique that is widely used in the communications industry, is to introduce redundancy in the data to be transmitted over a communications channel. Turbo encoders and decoders, therefore, allow communications systems to achieve an optimized data reception having the fewest errors. The redundant data allows recovery of the original data from the received data while achieving near Shannon-limit performance. Turbo decoding uses a decoding scheme called the MAP (maximum a posteriori probability) algorithm, which determines the probability of whether each received data symbol is a “one” or a “zero”.

When using a double-throughput MAP decoder for Turbo decoding, a double-data read from memory to the MAP decoder or a double-data write from the MAP decoder to memory needs to be done in a single clock time. A simple method to support these double-data access requirements is to use either dual-port memory or use two copies of the memory. However, these approaches significantly increase system complexity. Another method may attempt to use memory partitioning.

Memory partitioning employing single-port RAM basically divides a memory block into small multiple sub-blocks. Partitioning rules include either even/odd, blocksize/2 (lower half-block and upper half-block), or MSB-based (where MSB equals either one or zero). Although memory partitioning provides an advantage in hardware complexity, since ideally the same memory bank sizes can be used, a memory collision problem arises when two sets of data are accessing the same memory bank in a given clock cycle. Indeed, Turbo decoding consists of two MAP decodings wherein the second MAP decoding is performed in an interleaved order thereby allowing two requested addresses to employ the same sub-block. For example, if data are stored by even/odd partitioning, even MAP decoding are accessed as shown below:

| EVEN MAP DECODING | | ODD MAP DECODING | |
|---|---|---|---|
| FIRST MAP | SECOND MAP | FIRST MAP | SECOND MAP |
| 0 | 1 | i (0) | i (1) |
| 2 | 3 | i (2) | i (3) |
| 4 | 5 | i (4) | i (5) |
| 6 | 7 | i (6) | i (7) |
| . | . | . | . |
| . | . | . | . |
| . | . | . | . |

where i(x) is the interleaver address of x. Suppose i(0)=1, i(1)=4, i(2)=10, i(3)=5, i(4)=11, i(5)=7, i(6)=13 and i(7)=8, and also even/odd partitioning rules are used, it may be seen that:

ODD MAP DECODING

| FIRST MAP | SECOND MAP |
|---|---|
| 1 | 4 |
| 10 | 5 |
| 11 | 7 |
| 13 | 8 |
| . | . |
| . | . |
| . | . |

For the case where i(4)=11 and i(5)=7, two addresses are attempting to access the same memory bank thereby representing a memory collision, since no more than one access is allowed at the same time in a single-port RAM. This collision occurs in any partitioning scheme.

Accordingly, what is needed in the art is an enhanced way to avoid memory collisions in a dual-throughput MAP decoder employing single-port RAMs.

### SUMMARY OF THE INVENTION

To address the above-discussed deficiencies of the prior art, the present invention provides a collision avoidance manager for use with single-port memories. In one embodiment, the collision avoidance manager includes a memory structuring unit configured to provide a memory arrangement of the single-port memories having upper and lower memory banks arranged into half-memory portions. Additionally, the collision avoidance manager also includes a write memory alignment unit coupled to the memory structuring unit and configured to provide double-data writing to the memory arrangement based on memory collision avoidance. In a preferred embodiment, the collision avoidance manager also includes a read memory alignment unit coupled to the memory structuring unit and configured to provide double-data reading from the memory arrangement while maintaining memory collision avoidance.

In another aspect, the present invention provides a method of avoiding a memory collision for use with single-port memories. In one embodiment, the method includes providing a memory arrangement of the single-port memories having upper and lower memory banks arranged into half-memory portions and further providing double-data writing to the memory arrangement based on memory collision avoidance. In an alternative embodiment, the method also includes providing double-data reading from the memory arrangement while maintaining memory collision avoidance.

The present invention also provides, in yet another aspect, a turbo decoder. The turbo decoder includes double-throughput MAP decoder and a collision avoidance manager coupled to the MAP decoder. In one embodiment, the collision avoidance manager has a memory structuring unit that provides a memory arrangement of single-port memories having upper and lower memory banks arranged into half-memory portions. The collision avoidance manager also has a write memory alignment unit, coupled to the memory structuring unit, that provides double-data writing to the memory arrangement based on memory collision avoidance, and a read memory alignment unit, also coupled to the memory structuring unit, that provides double-data reading from the memory arrangement while maintaining memory collision avoidance. The turbo decoder also includes an interleaver memory coupled to the collision avoidance manager.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of a Turbo decoder constructed in accordance with the principles of the present invention;

FIG. 2 illustrates a block diagram of a write memory alignment unit constructed in accordance with the principles of the present invention;

FIGS. 3A and 3B illustrate embodiments of a data arbitrator and an associated logic table constructed in accordance with the principles of the present invention;

FIG. 4 illustrates a block diagram of an embodiment of a read memory alignment unit constructed in accordance with the principles of the present invention;

FIG. 5 illustrates an embodiment of circular buffers as may be employed with the data alignment unit, which was discussed with respect to FIG. 4; and

FIG. 6 illustrates a flow diagram of an embodiment of a method of avoiding a memory collision carried out in accordance with the principles of the present invention.

### DETAILED DESCRIPTION

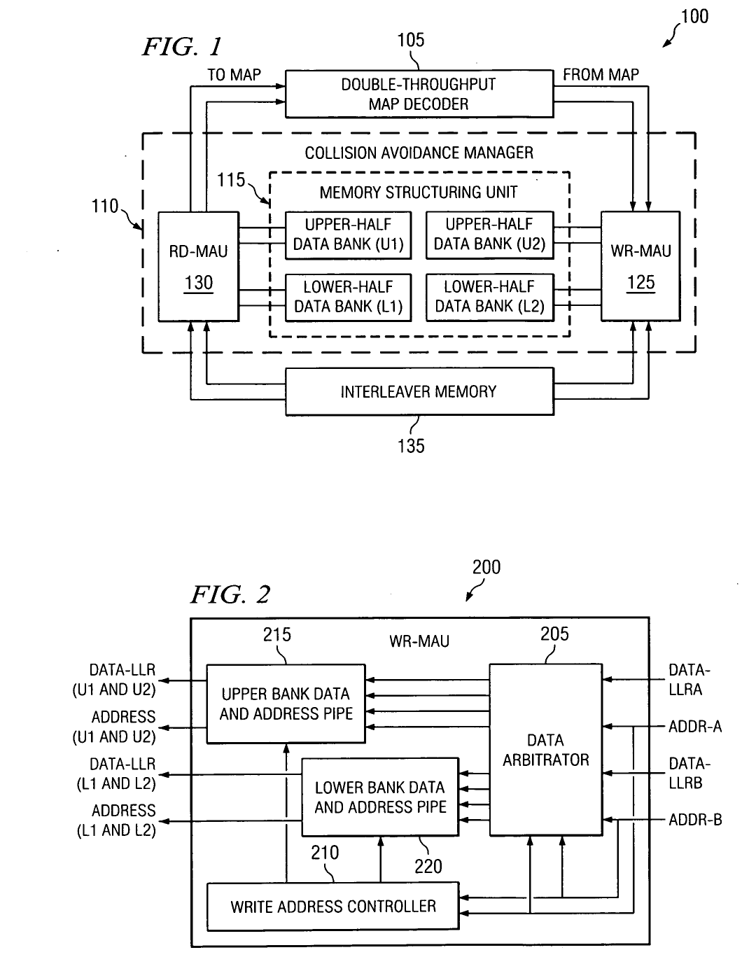

Referring initially to FIG. 1, illustrated is a system diagram of an embodiment of a Turbo decoder, generally designated 100, constructed in accordance with the principles of the present invention. The Turbo decoder 100 employs a maximum a posteriori probability (MAP) algorithm and includes a double-throughput MAP decoder 105, a collision avoidance manager 110 and an interleaver memory 135. In the illustrated embodiment, the collision avoidance manager 110 includes a memory structuring unit 115, a write memory alignment unit (WR-MAU) 125 and a read memory alignment unit (RD-MAU) 130.

The memory structuring unit 115 includes first and second upper-half data banks U1, U2 and first and second lower-half data banks L1, L2 wherein each consists of an independent single-port RAM. The single-port memories store logarithmic likelihood ratio (LLR) information that the probability of an extrinsic information bit is a zero divided by the probability that the extrinsic information bit is a one.

In the illustrated embodiment, the Turbo decoder 100 may be used with either a WCDMA/HSDPA system or CDMA 1x/EVDV having more than 10 Mbps throughput. The algorithmic BER performance requires up to 8 iterations through the dual-throughput MAP decoder 105. In order to meet the throughput requirements, the double-throughput decoder 105 therefore requires a double-data read from the memory structuring unit 115 to the double-throughput decoder 105 and a double-data write from double-throughput decoder 105 to the memory structuring unit 115 in a single clock cycle.

In the illustrated embodiment, the double-throughput MAP decoder 105 processes maximum block size data sequences in the worst case. Therefore, the first upper-half and lower-half data banks U1, L1 contain about half block-size memory locations apiece corresponding to a first decoder portion. Correspondingly, the second upper-half and lower-half data banks U2, L2 contain about half block-size memory locations apiece corresponding to a second decoder portion. First and second MAP decodings are required for one Turbo decoding, and the second MAP decoding is performed in an interleaved order thereby requiring two requested addresses to occur in the memory structuring unit 115 at the same time. The interleaver memory 135 retains interleave address information for the decoding process.

Embodiments of the present invention employ the WR-MAU 125 and the RD-MAU 130 to prevent memory collisions in the memory structuring unit 115, which helps the single-port memories that do not individually support dual access requests. These units basically fetch the required data from memory and send them to the dual-throughput MAP decoder 105 in the case of the RD-MAU 130 or retrieve data from the dual-throughput MAP decoder 105 and send them to memory in the case of the WR-MAP 125.

Turning now to FIG. 2, illustrated is a block diagram of a write memory alignment unit, generally designated 200, constructed in accordance with the principles of the present invention. The WR-MAU 200 includes a data arbitrator 205 having data and address inputs associated with a first MAP decoder A corresponding to Data-LLRA, Addr-A, and a second MAP decoder B corresponding to Data-LLRB, Addr-B. The WR-MAU 200 also includes a write address controller 210 and upper bank and lower bank data and address pipes 215, 220, which respectively provide data and address outputs Data-LLR(U1&U2), Address(U1&U2) and Data-LLR(L1&L2), Address(L1&L2). In the illustrated embodiment, the upper bank and lower bank data and address pipes 215, 220 are registers having a queue.

Each of the upper and lower data banks U1, U2 and L1, L2 (as may be seen in FIG. 1) accommodate the same amount of data over the long term. However, in the short term, data in the upper bank and lower bank data and address pipes 215, 220 may not be equal due to short-term data input fluctuations. A maximum amount of data input unbalance determines the buffering capability or length required for the upper bank and lower bank data and address pipes 215, 220. This may be determined by calculation or simulation for a particular application.

In the illustrated embodiment, there may be two active values of the incoming data Data-LLRA, Data-LLRB presented to the data arbitrator 205 at a given time. Alternatively, there may be only one active value or even no active values presented. The data arbitrator 205 looks at the address inputs Addr-A, Addr-B corresponding to the data inputs Data-LLRA, Data-LLRB and assigns them to the upper bank and lower bank data and address pipes 215, 220, as appropriate.

The address inputs of the two data inputs may indicate that both data inputs are directed to the upper bank data and address pipes 215 or both be directed to the lower bank data and address pipes 220. Alternatively, the data inputs may be shared between the upper bank and lower bank data and address pipes 215, 220. In the case of no active value data inputs, neither of the upper bank or lower bank data and address pipes 215, 220 have data inputs. Therefore, the possible number of active value data inputs at any given time is two, one or zero.

In the write address controller 210, this number of active data inputs is increased at the pointer. However, since data is progressing out of the upper bank and lower bank data and address pipes 215, 220 during every cycle, a one is subtracted in associated pointer calculations. To summarize, the pointer update equations may be expressed as:
Pointer_UpperBank=Pointer_UpperBank+Num_of_UpperBank_data−1; (1)
Pointer_LowerBank=Pointer_LowerBank+Num_of_LowerBank_data−1. (2)
In a well designed random interleave, the effective delay from beginning to the final time is usually very small. So, the overhead in timing is negligible.

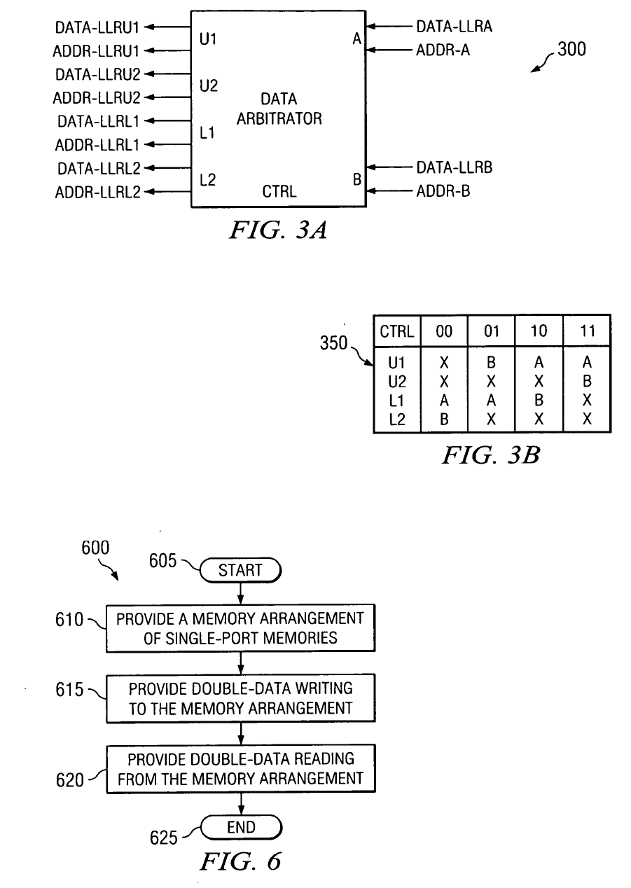

Turning now to FIGS. 3A and 3B, illustrated are embodiments of a data arbitrator and an associated logic table, generally designated 300, 350, constructed in accordance with the principles of the present invention. The data arbitrator 300 employs data and address inputs associated with a first MAP decoder A corresponding to Data-LLRA, Addr-A, and a second MAP decoder B corresponding to Data-LLRB, Addr-B. The data arbitrator 300 provides data and address outputs associated with first and second upper-half data banks U1, U2 and first and second lower-half data banks L1, L2. The first and second upper-half data banks U1, U2 include the data and address outputs Data-LLRU1, Addr-LLRU1, Data-LLRU2, Addr-LLRU2, and the first and second lower-half data banks L1, L2 include data and address outputs Data-LLLRU1, Addr-LLRL1, Data-LLRL2, Addr-LLRL2. The data arbitrator 300 further employs a control signal CLTR.

The data arbitrator 300 provides a more detailed representation of an output structure for the data arbitrator 205 discussed with respect to FIG. 2. The data arbitrator logic table 350 depicts arbitration employed by the data arbitrator 300 for input data and addresses from the first and second MAP decoders A,B based on a condition of the control signal CLTR. This data arbitration is directed to upper data bank and lower data bank memories U1, U2 and L1, L2, as shown in FIG. 1, to provide memory collision avoidance performance. Shift-registering operation is performed for a register (for the data with address<WR-pointer). Load operation is performed for a WR-pointer location.
wr_upper_ptr=(wr_upper_ptr−1)+num_of upper_data, (3)
wr_lower_ptr=(wr_lower_ptr−1)+num_of_lower_data, (4)
if wr_upper_ptr<0 then wr_upper_ptr=0, (5)
if wr_lower_ptr<0 then wr_lower_ptr=0, (6)
where
−1: due to the read operation
num_of_upper_data, num_of_lower_data={0, 1, 2}.

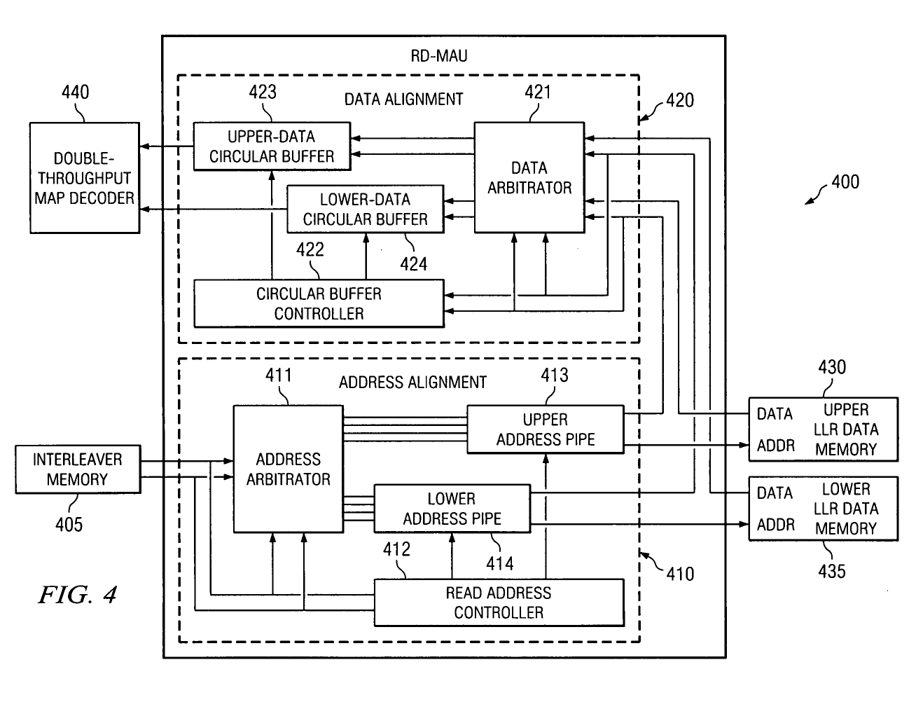

Turning now to FIG. 4, illustrated is a block diagram of an embodiment of a read memory alignment unit, generally designated 400, constructed in accordance with the principles of the present invention. The read memory alignment unit (RD-MAU) 400 includes an address alignment unit 410 and a data alignment unit 420. The address alignment unit 410 includes an address arbitrator 411, a read address controller 412 and upper and lower address pipes 413, 414. The data alignment unit 420 includes a data arbitrator 421, a circular buffer controller 422 and upper-data and lower-data circular buffers 423, 424.

The address alignment unit 410 receives address information from an interleaver memory 405, which is employed by the address alignment unit 410 to retrieve data from upper and lower LLR data memory banks 430, 435. This data is then properly aligned by the data alignment unit 420 and provided to each of first and second MAP decoders A, B employed in a double-throughput MAP decoder 440.

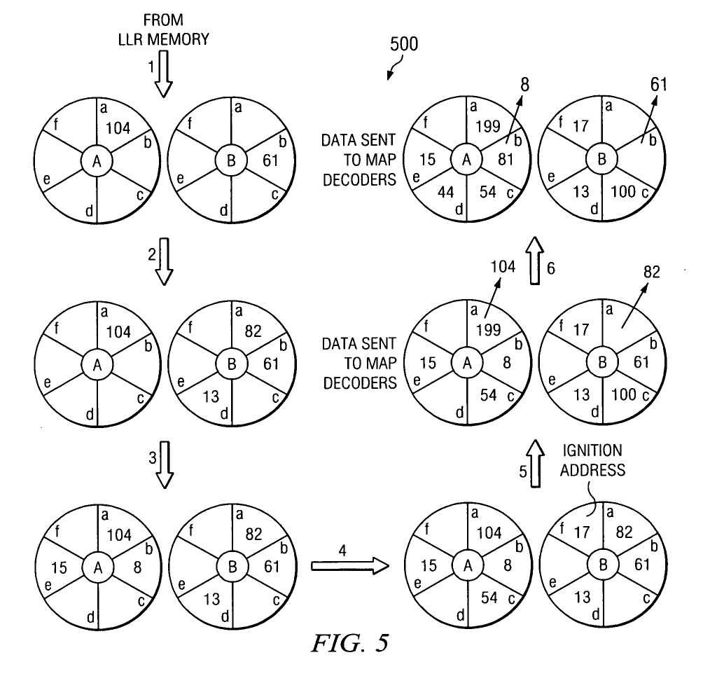

Using two given addresses provided from the interleaver memory 405, these addresses are aligned to access the upper and lower LLR data memories 430, 435 to retrieve the required data in a manner analogous to writing the data in the WR-MAU, which is designed to avoid memory collisions. However, the data was shuffled during the collision avoidance writing process and needs to be placed in the original order needed by the first and second MAP decoders A, B. To accomplish this, reshuffle information, which is basically a small counter output needs to be stored and realigned in the upper and lower circular buffers 423, 424. An example of this reshuffling process is discussed in FIG. 5 below.

Turning now to FIG. 5, illustrated is an embodiment of circular buffers, generally designated 500, as may be employed with the data alignment unit 420, which was discussed with respect to FIG. 4. The circular buffers 500 demonstrate six states of data buffering (1-6) from an LLR memory such as the upper and lower LLR memory data banks 425, 430 shown in FIG. 4. Each of the six states of data buffering also employs six stages a-f of data buffering for two buffers A, B, in the illustrated embodiment.

The buffers A, B may correspond to the first and second MAP decoders A, B of FIG. 4. The numbers shown in the stages a-f represent data for the respective first and second MAP decoders A, B. This data continues to accrue in the buffers until an ignition point is reached. The ignition point is typically determined by operational simulation of the buffers A, B indicating when they have reached a critical buffering point. At the ignition point, the buffers A, B start sending the buffered data to the first and second MAP decoders A, B, as shown. The decoding delay or latency is only four cycles in the example shown.

Turning now to FIG. 6, illustrated is a flow diagram of an embodiment of a method of avoiding a memory collision, generally designated 600, carried out in accordance with the principles of the present invention. The method 600 is for use with single-port memories and starts in a step 605. Then, in a step 610, a memory arrangement of the single-port memories is provided having upper and lower memory banks arranged into half-memory portions. This arrangement allows memory collisions to be avoided while employing both memory writing and reading operations.

In a step 615, double-data writing to the memory arrangement of the single-port memories is provided based on employing memory collision avoidance. The double-data writing employs data arbitration between the upper and lower memory banks to provide the memory collision avoidance. Additionally, the double-data writing employs upper and lower data and address pipes having address pipes to control write addresses in such a way as to provide the memory collision avoidance in the upper and lower memory banks.

In a step 620, double-data reading from the memory arrangement is provided while maintaining the memory collision avoidance. The double-data reading employs address alignment and data alignment of the upper and lower memory banks to maintain the memory collision avoidance. Additionally, in the step 620, the address alignment employs address arbitration between the upper and lower memory banks and upper and lower address pipes employing control of read addresses for the upper and lower memory banks.

In the step 620, data alignment employs data arbitration between the upper and lower memory banks to maintain the memory collision avoidance. Additionally, the data alignment employs upper and lower data buffering corresponding to the upper and lower memory banks to maintain the memory collision avoidance. In one embodiment, circular buffering employing a circular buffer controller provides the upper and lower data buffering. The method 600 ends in a step 625.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a collision avoidance manager, a method of avoiding a memory collision and a turbo decoder employing the manager or the method have been presented. Advantages include a significant reduction in system complexity compared with the use of dual-port memory while requiring a marginal additional latency of only a few clock cycles. In addition, implementation of the embodiments is straightforward and may be accomplished employing either single-port memories or shift registers. As compared to conventional solutions for mobile wireless communication receivers where chip real estate (chip size) and power consumption are very important, MAP memory for Turbo decoding applications employing the collision avoidance manager or the method of avoiding a memory collision offer reduced memory size as well as reduced power consumption.

Although the present invention has been described in detail, those skilled in the art should understand that they can make various changes, substitutions and alterations herein without departing from the spirit and scope of the invention in its broadest form.

What is claimed is:

1. A collision avoidance manager for use with single-port memories, comprising:
a memory structuring unit configured to provide a memory arrangement of said single-port memories having upper and lower memory banks arranged into half-memory portions; and
a write memory alignment unit coupled to said memory structuring unit and configured to provide double-data writing to said memory arrangement based on memory collision avoidance.

2. The manager as recited in claim 1 wherein said double-data writing employs data arbitration between said upper and lower memory banks to provide said memory collision avoidance.

3. The manager as recited in claim 1 wherein said double-data writing employs upper and lower data and address pipes corresponding to said upper and lower memory banks to provide said memory collision avoidance.

4. The manager as recited in claim 3 wherein said upper and lower data and address pipes employ controlling of write addresses to provide said memory collision avoidance.

5. The manager as recited in claim 1 further comprising a read memory alignment unit coupled to said memory structuring unit and configured to provide double-data reading from said memory arrangement while maintaining said memory collision avoidance.

6. The manager as recited in claim 5 wherein said double-data reading employs address alignment and data alignment of said upper and lower memory banks to maintain said memory collision avoidance.

7. The manager as recited in claim 6 wherein said address alignment employs address arbitration between said upper and lower memory banks to maintain said memory collision avoidance.

8. The manager as recited in claim 6 wherein said address alignment employs upper and lower address pipes corresponding to said upper and lower memory banks to maintain said memory collision avoidance.

9. The manager as recited in claim 8 wherein said upper and lower address pipes employ controlling of read addresses to maintain said memory collision avoidance.

10. The manager as recited in claim 6 wherein said data alignment employs data arbitration between said upper and lower memory banks to maintain said memory collision avoidance.

11. The manager as recited in claim 6 wherein said data alignment employs upper and lower data buffering corresponding to said upper and lower memory banks to maintain said memory collision avoidance.

12. The manager as recited in claim 11 wherein said upper and lower data buffering are provided by circular buffering employing a circular buffer controller.

13. A method of avoiding a memory collision for use with single-port memories, comprising:
providing a memory arrangement of said single-port memories having upper and lower memory banks arranged into half-memory portions; and
further providing double-data writing to said memory arrangement based on memory collision avoidance.

14. The method as recited in claim 13 wherein said double-data writing employs data arbitration between said upper and lower memory banks to provide said memory collision avoidance.

15. The method as recited in claim 13 wherein said double-data writing employs upper and lower data and address pipes corresponding to said upper and lower memory banks to provide said memory collision avoidance.

16. The method as recited in claim 15 wherein said upper and lower data and address pipes employ controlling of write addresses to provide said memory collision avoidance.

17. The method as recited in claim 13 further comprising providing double-data reading from said memory arrangement while maintaining said memory collision avoidance.

18. The method as recited in claim 17 wherein said double-data reading employs address alignment and data alignment of said upper and lower memory banks to maintain said memory collision avoidance.

19. The method as recited in claim 18 wherein said address alignment employs address arbitration between said upper and lower memory banks to maintain said memory collision avoidance.

20. The method as recited in claim 18 wherein said address alignment employs upper and lower address pipes corresponding to said upper and lower memory banks to maintain said memory collision avoidance.

21. The method as recited in claim 20 wherein said upper and lower address pipes employ controlling of read addresses to maintain said memory collision avoidance.

22. The method as recited in claim 18 wherein said data alignment employs data arbitration between said upper and lower memory banks to maintain said memory collision avoidance.

23. The method as recited in claim 18 wherein said data alignment employs upper and lower data buffering corresponding to said upper and lower memory banks to maintain said memory collision avoidance.

24. The method as recited in claim 23 wherein said upper and lower data buffering are provided by circular buffering employing a circular buffer controller.

25. A turbo decoder, comprising:
a double-throughput MAP decoder;
a collision avoidance manager coupled to said MAP decoder, including:
a memory structuring unit that provides a memory arrangement of single-port memories having upper and lower memory banks arranged into half-memory portions,
a write memory alignment unit, coupled to said memory structuring unit, that provides double-data writing to said memory arrangement based on memory collision avoidance, and
a read memory alignment unit, coupled to said memory structuring unit, that provides double-data reading from said memory arrangement while maintaining said memory collision avoidance; and
an interleaver memory coupled to said collision avoidance manager.

26. The turbo decoder as recited in claim 25 wherein said double-data writing employs data arbitration between said upper and lower memory banks to provide said memory collision avoidance.

27. The turbo decoder as recited in claim 25 wherein said double-data writing employs upper and lower data and address pipes corresponding to said upper and lower memory banks to provide said memory collision avoidance.

28. The turbo decoder as recited in claim 27 wherein said upper and lower data and address pipes employ controlling of write addresses to provide said memory collision avoidance.

29. The turbo decoder as recited in claim 25 wherein said double-data reading employs address alignment and data alignment of said upper and lower memory banks to maintain said memory collision avoidance.

30. The turbo decoder as recited in claim 29 wherein said address alignment employs address arbitration between said upper and lower memory banks to maintain said memory collision avoidance.

31. The turbo decoder as recited in claim 29 wherein said address alignment employs upper and lower address pipes corresponding to said upper and lower memory banks to maintain said memory collision avoidance.

32. The turbo decoder as recited in claim 31 wherein said upper and lower address pipes employ controlling of read address to maintain said memory collision avoidance.

33. The turbo decoder as recited in claim 29 wherein said data alignment employs data arbitration between said upper and lower memory banks to maintain said memory collision avoidance.

34. The turbo decoder as recited in claim 29 wherein said data alignment employs upper and lower data buffering corresponding to said upper and lower memory banks to maintain said memory collision avoidance.

35. The turbo decoder as recited in claim 34 wherein said upper and lower data buffering are provided by circular buffering employing a circular buffer controller.
